(19) United States
(12) Patent Application Publication
(10) Pub. No.: US 2007/0074656 A1
(43) Pub. Date: Apr. 5, 2007

(54) Non-clogging powder injector for a kinetic spray nozzle system

(76) Inventors: Zhibo Zhao, Novi, MI (US); Bryan A. Gillispie, Macomb Township, MI (US); TaeYoung Han, Bloomfield Hills, MI (US); John S. Rosen JR., Williamsville, NY (US); Michael John Irish, Getzville, NY (US)

Correspondence Address: DELPHI TECHNOLOGIES, INC., M/C 480-410-202, PO BOX 5052, TROY, MI, 48007, US

(21) Appl. No.: 11/243,467

(22) Filed: Oct. 4, 2005

(51) Int. Cl. B05C 19/00

(52) U.S. Cl. 118/308

(57) ABSTRACT

An improved kinetic spray nozzle system design is disclosed. The nozzle includes an improved powder injector having an injector tube and a sleeve wherein the injector tube is received in the sleeve and secured to the sleeve. The powder injector further includes an air gap defined between an inner diameter of the sleeve and an outer diameter of the injector tube wherein the air gap is from 50 to 200 microns. The improved injector is capable of spraying a variety of powder materials including hard and “gummy” powders for without clogging for extended periods of time whereas under similar spray conditions previous designs became completely plugged within minutes. The improved injector design enabled the use of higher main gas temperatures to achieve improved coating formation and deposition efficiencies. Most importantly, the improved design makes it possible to use the kinetic spray system with a wide range of powder materials in a manufacturing setting without interruptions caused by powder injector clogging related problems.

### TECHNICAL FIELD

The present invention is related to the field of kinetic spraying, more particularly, the present invention relates to an improved powder injector for a kinetic spray nozzle system. The powder injector overcomes problems of clogging associated with the prior powder injector and at the same time improves the coating formation by the kinetic spray process.

### INCORPORATION BY REFERENCE

U.S. Pat. No. 6,139,913, “Kinetic Spray Coating Method and Apparatus” and U.S. Pat. No. 6,283,386, “Kinetic Spray Coating Apparatus” and incorporated by reference herein.

### RELATED APPLICATIONS

None.

### BACKGROUND OF THE INVENTION

In U.S. Pat. No. 5,302,414, issued Apr. 12, 1994, by Alkimov et al. a process was disclosed for producing dense continuous layer coatings with powder particles having a particle size of from 1 to 50 microns using a supersonic nozzle and a spraying technique. This technique has come to be known in the art as kinetic spraying or cold dynamic gas spraying.

The basics of the technique were reported in an article by T. H. Van Steenkiste et al., entitled “Kinetic Spray Coatings,” published in Surface and Coatings Technology, vol. 111, pages 62-71, Jan. 10, 1999. The article discusses producing continuous layer coatings having low porosity, high adhesion, low oxide content and low thermal stress. The article describes coatings being produced by entraining metal powders in an accelerated gas stream, through a converging-diverging de Laval type nozzle and projecting them against a target substrate. The particles are accelerated in the high velocity gas stream by the drag effect. The gas used can be any of a variety of gases including air, nitrogen, helium or other noble gasses. It was found that the particles that formed the coating did not melt or thermally soften prior to binding onto the substrate. It is theorized that the particles adhere to the substrate when their kinetic energy is converted to a sufficient level of thermal energy and mechanical deformation. Thus, it is believed that the particle velocity must be high enough to exceed a critical velocity to permit it to adhere when it strikes the substrate. This makes kinetic spraying completely different from all forms of thermal spraying. All thermal spraying systems have in common the feature that the material being sprayed is melted in the spray apparatus and the material strikes the substrate in a molten state. Thus, all materials whether they be powders, solid state particles, etc. sprayed by a thermal spray method undergo a phase change during the spraying process.

It was found that the deposition efficiency of a given particle mixture was increased as the inlet gas temperature was increased in the kinetic spray process. Increasing the inlet gas temperature decreases its density and increases its velocity. The gas velocity varies approximately as the square root of the inlet gas temperature. The actual mechanism of bonding of the particles to the substrate surface is not fully understood at this time. It is believed that the particles must exceed a critical velocity prior to their impingement on the substrate to form a bond to the substrate. The critical velocity is dependent on the material of the particle and harder materials tend to have higher critical velocities. It is believed that the initial particles to adhere to a substrate have broken the oxide shell on the substrate material permitting subsequent metal to metal bond formation between plastically deformed particles and the substrate. Once an initial layer of particles has been formed on a substrate subsequent coating formation also involves particle to particle bonding. The bonding process is not due to melting of the particles in the gas stream because the temperature of the particles is always below their melting temperature. The particle temperature is usually lower than the gas stream temperature. This is typical because the exposure time of the particles to the gas stream is relatively short.

The Van Steenkiste article reported on work conducted by the National Center for Manufacturing Sciences (NCMS) to improve on the earlier Alkimov process and apparatus. Van Steenkiste et al. demonstrated that Alkimov's apparatus and process could be modified to produce kinetic spray coatings using particle sizes of greater than 50 microns and up to about 106 microns.

This modified process and apparatus for producing such larger particle size kinetic spray continuous layer coatings are disclosed in U.S. Pat. Nos. 6,139,913, and 6,283,386. The process and apparatus provide for heating a high pressure gas flow up to about 650° C. and combining this with a flow of particles. The heated gas and particles are directed through a de Laval-type nozzle to produce a particle exit velocity of between about 300 m/s (meters per second) to about 1000 m/s. The thus accelerated particles are directed toward and impact upon a target substrate with sufficient kinetic energy to bind the particles to the surface of the substrate. The temperatures used still are sufficiently lower than that necessary to cause particle melting or thermal softening of the selected particle. Therefore, no phase transition occurs in the particles prior to binding and during the process of binding. It has been found that each type of particle material has a threshold critical velocity that must be exceeded before the material will adhere to a given substrate.

All kinetic spray systems use a powder injector to inject the powder particles being sprayed into the nozzle where they mix with the gas stream, are entrained in and heated in the gas stream, and from which they are sprayed onto a substrate. The gas stream used to entrain the particles is conventionally known as the main gas to differentiate it from the injection gas stream used to inject the particles into the nozzle. The driving force in a typical system for getting the powder entrained in the main gas stream is a pressure differential of from 20 to 50 psi in the injection gas stream over the pressure of the main gas stream. The pressures of the main gas stream are from 200 to 500 pounds per square inch (psi), more preferably from 280 to 350 psi. Typically, the main gas is heated to a temperature of from 250 to 1000° C. or higher to produce the required acceleration of the particles being sprayed. Thus, the powder injector is exposed to very high temperatures and is heated itself to high temperatures. The powder injector including the injector tube, which actually carries the particles, is often made from stainless steel. Because of the heating by the main gas the injector tube can often become plugged with the particles being sprayed. This can be a very significant problem with particles that get “gummy” as they are heated. The heated particles can stick to the inside walls of the injector tube and in many cases the injector tube can become plugged in 2 to 10 minutes, depending on the material being sprayed. It is a self perpetuating cycle in that the flow of the injector gas stream, which is usually not heated from ambient temperature, initially serves to cool the injector tube. Sufficient powder gas flow in the injector is necessary to prevent particles from being deposited onto the inside wall of the injector tube. High injector gas flow rates, however, tend to lower the effective temperature of the main gas because of their temperature difference. This often causes degradation of the nozzle performance. Therefore, the use of high gas flow rates through the injector tube to prevent plugging is not practical. When particles are deposited in the inside wall of the injector tube the effective cross-sectional area of the injector decreases further restricting gas flow which further reduces the cooling effect in the cycle described above. This in turn accelerates the rate of deposition of particles on the inside of the injector tube, which further reduces the flow of injector gas and eventually causes the injector to be completely plugged. Once the injector tube is plugged the entire system must be shutdown and the injector replaced with a new one and the plugged one must be unplugged or discarded. Clearly, for kinetic spray to become a useful process in an industrial setting it will be necessary to overcome this limitation. To date no entirely satisfactory solutions have emerged. Thus, it would be beneficial to develop a system wherein the powder injector could function even at high temperatures and with traditionally “gummy” materials for extended periods of time without plugging of the injector tube.

### SUMMARY OF THE INVENTION

In one embodiment, the present invention is a powder injector for a kinetic spray nozzle system, the powder injector comprising: an injector tube and a sleeve; the injector tube received in the sleeve and secured to the sleeve; and an air gap defined between an inner diameter of the sleeve and an outer diameter of the injector tube wherein the air gap is from 50 to 200 microns.

### BRIEF DESCRIPTION OF THE DRAWINGS

FIG. 1 is a schematic diagram of a typical kinetic spray system according to the present invention;

FIG. 2A is a cross-sectional view of a kinetic spray nozzle with a prior art powder injector;

FIG. 2B is an expanded view of the prior art powder injector shown in FIG. 1;

FIG. 3A is a SEM micrograph of a cross-section of the exit end of an unused prior art powder injector tube;

FIG. 3B is a SEM micrograph of a cross-section of the exit end of a prior art powder injector tube after 10 minutes of use;

FIG. 4 is a cross-sectional view of one embodiment of a powder injector tube sleeve designed in accordance with the present invention;

FIG. 5 is a cross-sectional view of another embodiment of a powder injector tube sleeve designed in accordance with the present invention;

FIG. 6 is a cross-sectional view of another embodiment of a powder injector tube sleeve designed in accordance with the present invention;

FIG. 7A is a graph showing the theoretical effect of a 100 micron air gap between the sleeve and the injector tube on the temperature of powder injector tube as a function of the thermal conductivity of the powder injector tube sleeve;

FIG. 7B is a graph showing the theoretical effect of extending the powder injector tube sleeve beyond the exit end of the powder injector tube on the injector tube temperature at various positions on the injector tube;

FIG. 7C is a graph showing the theoretical effect of the changing the thickness of the powder injector tube sleeve on its ability to keep the powder injector tube cool;

FIG. 8A is a SEM micrograph of a cross-section of an interior portion of a powder injector tube designed according to the present invention after several hours of use;

FIG. 8B is a SEM micrograph of a cross-section of the exit end of a powder injector tube designed according to the present invention after several hours of use; and

FIG. 9 is a cross-sectional view of another embodiment of a powder injector tube designed in accordance with the present invention.

### DESCRIPTION OF A PREFERRED EMBODIMENT

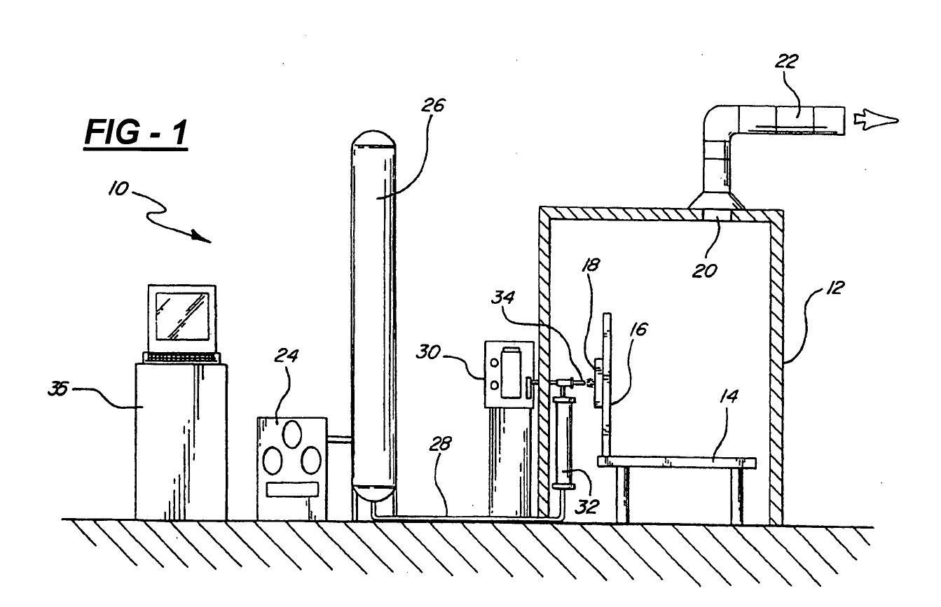

Referring first to FIG. 1, a kinetic spray system according to the present invention is generally shown at 10. System 10 includes an enclosure 12 in which a support table 14 or other support means is located. A mounting panel 16 fixed to the table 14 supports a work holder 18 capable of movement in three dimensions and able to support a suitable workpiece formed of a substrate material to be coated. The work holder 18 can also be capable of feeding a substrate material through the system 10. The enclosure 12 includes surrounding walls having at least one air inlet, not shown, and an air outlet 20 connected by a suitable exhaust conduit 22 to a dust collector, not shown. During coating operations, the dust collector continually draws air from the enclosure 12 and collects any dust or particles contained in the exhaust air for subsequent disposal.

The spray system 10 further includes a gas compressor 24 capable of supplying gas pressure up to 3.4 MPa (megaPascals), approximately 500 pounds per square inch (psi), to a high pressure gas ballast tank 26. The gas ballast tank 26 is connected through a line 28 to powder feeder 30 and a separate gas heater 32. The powder feeder 30 is typically a high pressure powder feeder. The gas heater 32 supplies high pressure heated gas, the main gas described below, to a kinetic spray nozzle 34. It is possible to provide the nozzle 34 with movement capacity in three directions in addition to or rather than the work holder 18. The pressure of the main gas generally is set at from 150 to 500 psi. The powder feeder 30 mixes particles of a spray powder with the gas at a desired pressure, higher than that of the main gas obviously, and supplies the mixture of particles to the nozzle 34. A computer control 35 operates to control the pressure of gas supplied to the gas heater 32 and the powder feeder 30 and it controls the temperature of the heated main gas exiting the gas heater 32. Useful gases include air, nitrogen, helium and other noble gasses.

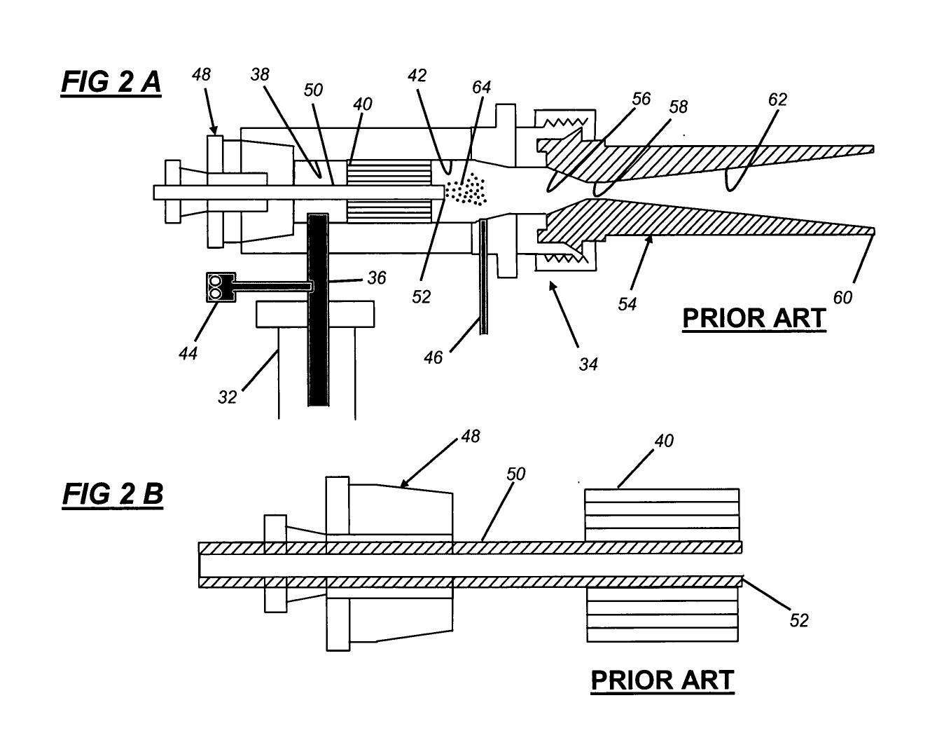

FIG. 2 is a cross-sectional view of a prior art embodiment of the nozzle 34 and its connections to the gas heater 32 and a high pressure powder feeder 30. A main gas passage 36 connects the gas heater 32 to the nozzle 34. Passage 36 connects with a premix chamber 38 that directs the main gas through a gas collimator 40 and into a mix chamber 42. Temperature and pressure of the heated main gas are monitored by a gas inlet temperature thermocouple 44 in the passage 36 and a pressure sensor 46 connected to the mix chamber 42. The main gas has a temperature that is always insufficient to cause melting in the nozzle 34 of any particles being sprayed. The main gas temperature can range from 93 to 1000° C. The temperature of the gas rapidly falls as it travels through the nozzle 34. In fact, the temperature of the gas measured as it exits the nozzle 34 could be at or below room temperature even when its initial temperature is well above 550° C. A powder injector 48 having an injector tube 50 is secured to the nozzle 34, preferably by threads. The injector tube 50 extends through the gas collimator 40 and an exit end 52 projects into the mix chamber 42. The injector tube 50 delivers the particles 64 into the mix chamber 42 wherein they mix with the heated main gas. The injector 48 and injector tube 50 are preferably formed from stainless steel and preferably the inner diameter of the injector tube is from 0.4 to 3.0 millimeters. The stainless steel used has a thermal conductivity of approximately 16.3 (W/m K).

Chamber 42 is in communication with a de Laval type supersonic nozzle 54. The nozzle 54 has an entrance cone 56 that decreases in diameter to a throat 58. The entrance cone 56 forms the converging region of the nozzle 54. Downstream from the throat 58 is an exit end 60 and a diverging region 62 is defined between the throat 58 and the exit end 60. The largest diameter of the entrance cone 56 may range from 5 to 20 millimeters, with 7.5 millimeters being preferred. The entrance cone 56 narrows to the throat 58. The throat 58 may have a diameter of from 0.5 to 5.5 millimeters, with from 3 to 2 millimeters being preferred. The diverging region of the nozzle 54 from downstream of the throat 58 to the exit end 60 may have a variety of shapes, but in a preferred embodiment it has a rectangular cross-sectional shape. At the exit end 60 the nozzle 54 preferably has a rectangular shape with a long dimension of from 6 to 20 millimeters by a short dimension of from 2 to 6 millimeters. The diverging region can have a length of from about 50 millimeters to about 500 millimeters.

The nozzle 54 produces an exit velocity of the entrained particles 64 of from 300 meters per second to as high as 1200 meters per second. The entrained particles 64 gain kinetic and thermal energy during their flow through this nozzle 54. It will be recognized by those of skill in the art that the temperature of the particles 64 in the main gas stream will vary depending on the particle size and the main gas temperature. The main gas temperature is defined as the temperature of heated high-pressure gas measured by the thermocouple 44. The temperature of the main gas is chosen based on the types of materials to be sprayed. Hard materials, which tend to be more difficult to spray with relatively high deposition efficiencies, often require higher main gas temperatures. The temperature of the particles 64 from main gas heating is less than the melting temperature of the particles 64, even upon impact, there is no change in the solid phase of the original particles 64 due to transfer of kinetic and thermal energy, and therefore no change in their original physical properties. The particles 64 themselves are always at a temperature below their melt temperature. The particles 64 exiting the nozzle 54 are directed toward a surface of a substrate to be coated.

As discussed above, an ongoing problem with current powder injectors 48 is their tendency to get plugged by the powder particles 64 during the spraying process. This problem restricts the use of higher main gas temperatures, which is often desired to achieve high deposition efficiency of difficult to spray materials. Most importantly, the clogging problem limits the ability to utilize the kinetic spray process in a manufacturing setting which requires long periods of operation of the spray system without frequent interruption. One common use for kinetic spraying has been to apply brazing alloys; these are especially prone to plugging of the injector tube 50. One such alloy that is used in the present invention as a test material is an alloy of 78% Al 12% Zn and 10% Si all by weight. In the experiments described below this alloy was used and its particle size range was from 53 to 106 microns. As would be understood by one of ordinary skill in the art any other particle material can be used in the present invention and the size range can be from 1 to 500 microns. The issue of plugging is especially prevalent with the more ductile materials such as the alloy noted above, copper, and copper alloys. This particular alloy was chosen because it has a tendency to plug injector tubes 50 within 2 to 10 minutes when sprayed at the temperature necessary for efficient deposition and thus it is an ideal test powder.

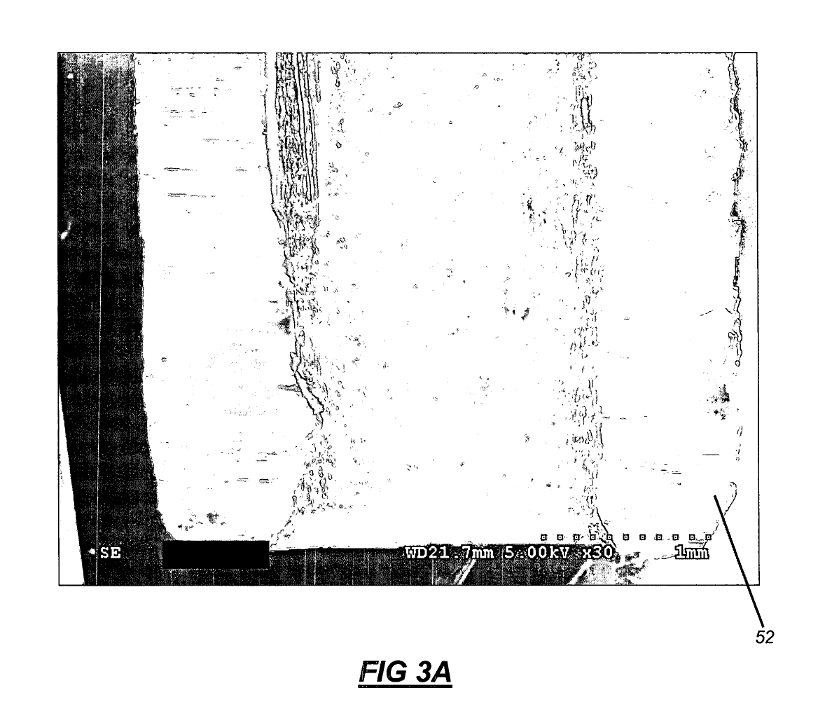

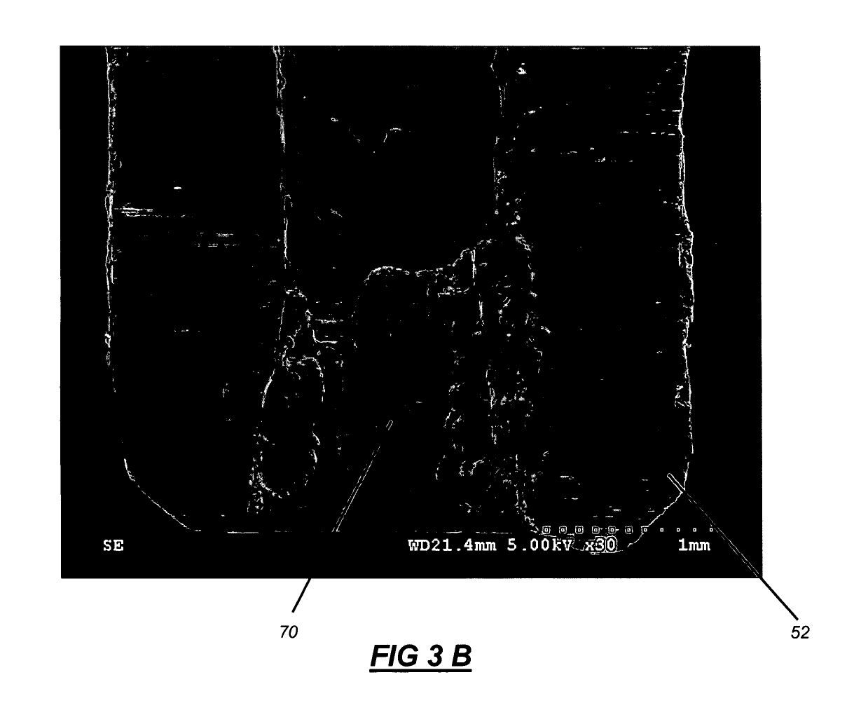

FIG. 3A is an SEM micrograph of a cross-section of the exit end 52 of an unused injector tube 50. FIG. 3B is an SEM micrograph of a cross-section of the exit end 52 of an injector tube 50 showing an almost complete plug of powder particles 70 after just 10 minutes of use at a main gas temperature of 537° C. The test powder was the Al—Zn—Si alloy described above and the pressure used on the injector 48 was 2.21 MPa while that of the main gas was 2.07 MPa. The exit end 52 tends to be the hottest portion of the injector tube 50.

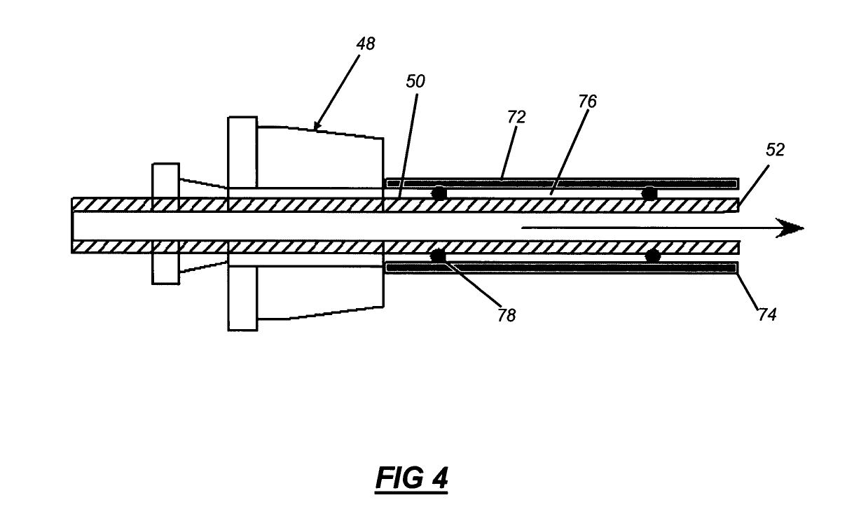

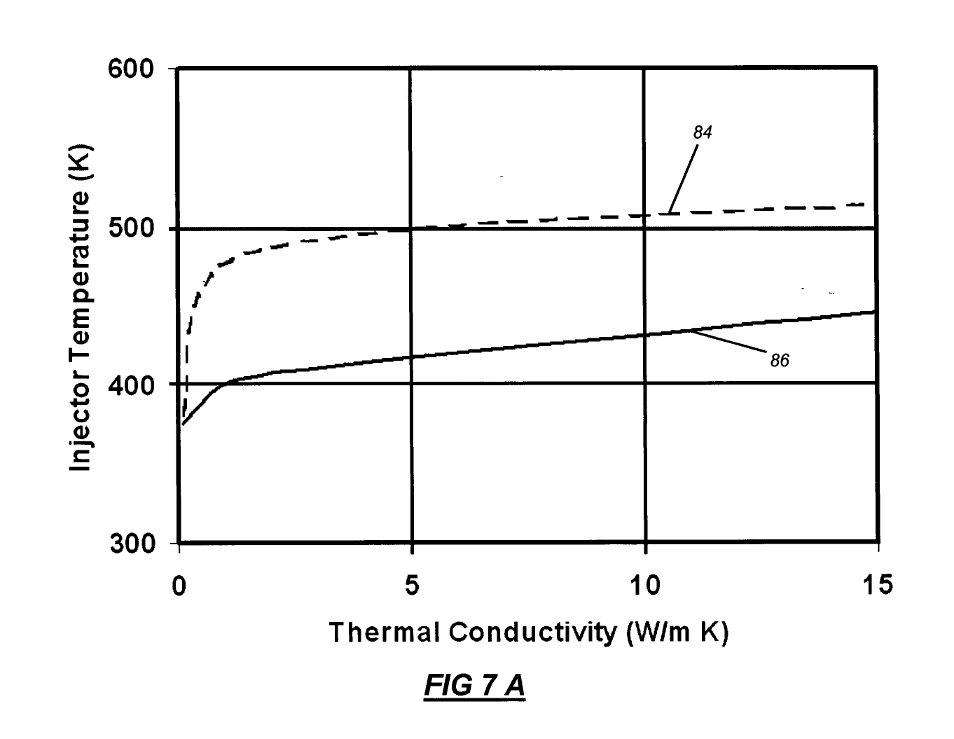

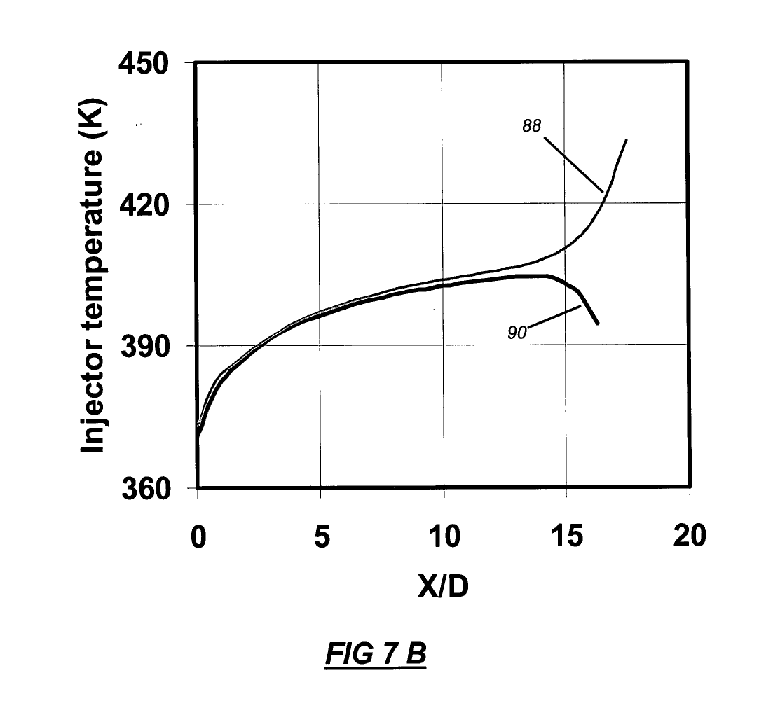

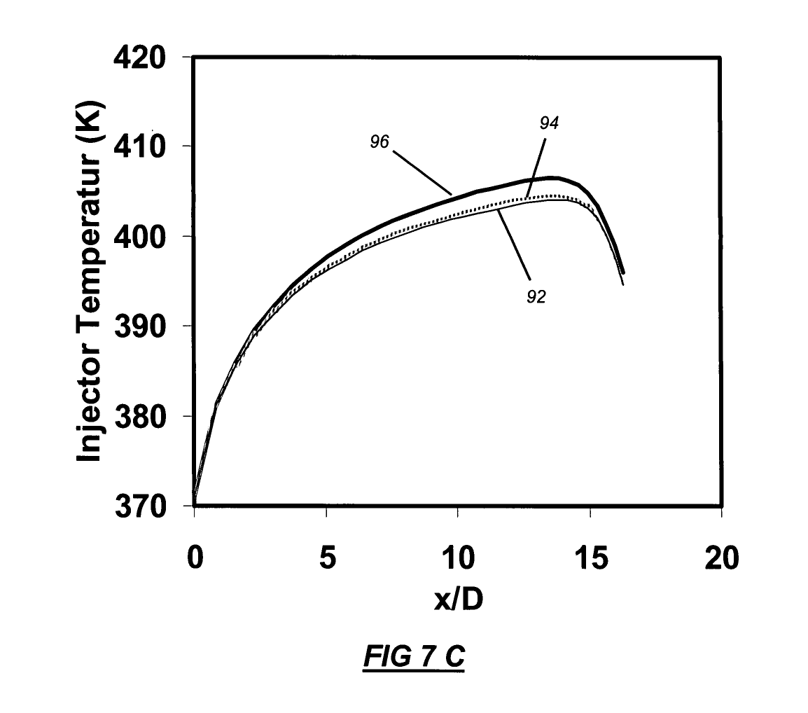

FIG. 4 is a cross-sectional view of one embodiment of an injector 48 designed in accordance with the present invention. The prior art injector 48 is modified by being inserted into an injector tube 50 sleeve 72. In this embodiment the sleeve 72 is secured to the injector tube 50 at a plurality of points by an adhesive 78. Any high temperature adhesive can be used and such are known in the art, thus will not be described. An air gap 76 is defined between the inner diameter of the sleeve 72 and the outer diameter of the injector tube 50. In this embodiment the exit end of the injector tube 50 is flush with an end 74 of the sleeve 72. It has been found that an air gap 76 is necessary for a number of reasons. First, it allows for thermal cycling of the sleeve 72 without fractures in the sleeve 72. This is because a tight fitting sleeve 72 is subject to more fractures because of the thermal stress due to mismatch of the thermal expansion of the different materials. In addition, as shown below in FIG. 7A the presence of the air gap 76, shown as reference line 86, enhances the ability of the sleeve 72 to maintain relatively lower wall temperatures of the injector tube 50 compared to the situation of no air gap as shown in reference line 84. Preferably, the air gap 76 is from 25 to 200 microns and more preferably from 50 to 150 microns. The adhesive 78 functions to form the air gap 76 in this embodiment. The sleeve 72 is formed from a material having a lower thermal conductivity than that of the injector tube 50, thus it thermally insulates the tube 50. Preferably, the sleeve 72 has a thermal conductivity of 15.00 W/m K or less, preferably 5.00 W/m K or less, most preferably 2.00 W/m K or less. Materials meeting these specifications include certain ceramic materials. Preferably the sleeve 72 is formed from a ceramic material or a machinable glass-ceramic material. Preferably the material can be used in high temperature applications of around 500° C. or higher. One especially useful material is the machinable glass-ceramic Macor® available from Dow Corning. This material has a thermal conductivity of 1.46 W/m K. The composition of Macor® is as follows, all as approximate weight percent: 46% SiO₂; 17% MgO; 16% Al₂O₃; 10% K₂O; 7% B₂O₃; and 4% F. It is readily machinable and can be used at high temperatures up to 800° C. and still maintains its functional performance. Other high temperature use materials can also be used. The sleeve 72 can also be formed by sintering or casting processes as are known to those of skill in the art.

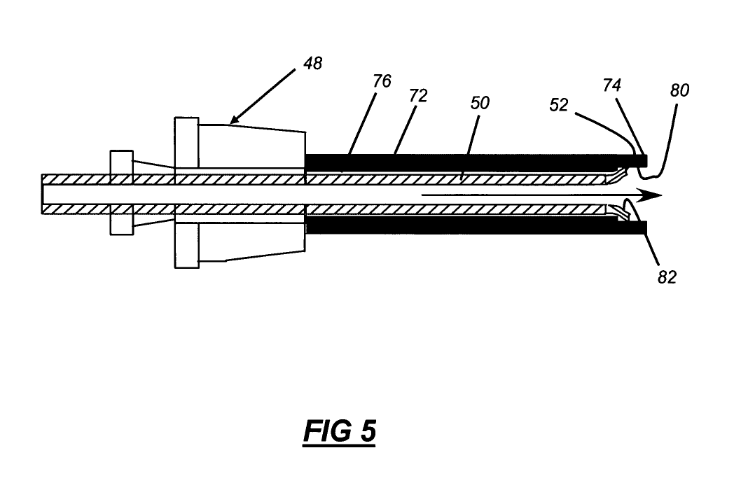

FIG. 5 is a cross-sectional view of another embodiment of a powder injector sleeve 72 designed in accordance with the present invention. In this embodiment the sleeve 72 includes a recessed portion 80 near its end 74. The injector tube 50 includes a flared portion 82 at its exit end 52. The flared portion 82 is received in the recessed portion 80 and secures the sleeve 72 to the injector tube 50. The air gap 76 is defined between the outer diameter of the injector tube 50 and the inner diameter of the sleeve 72 as above. This embodiment is very simple to execute and robust.

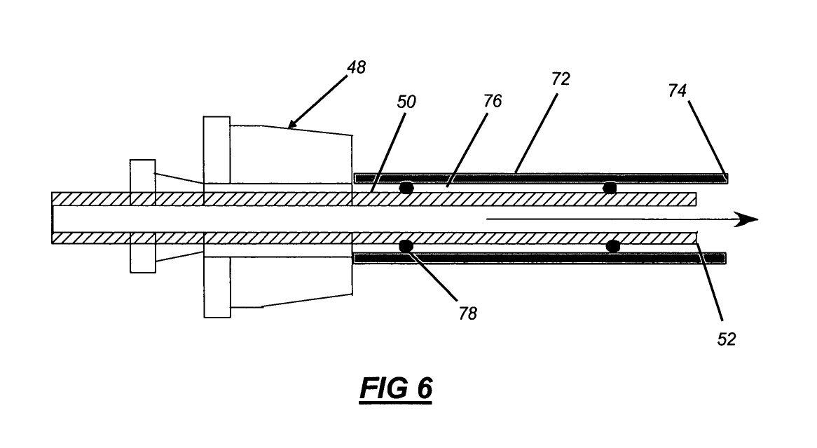

FIG. 6 is a cross-sectional view of another embodiment of a powder injector sleeve 72 designed in accordance with the present invention. In this embodiment the sleeve 72 has an end 74 that extends beyond the exit end 52 of the injector tube 50. As discussed below with respect to FIG. 7B extending the end 74 beyond the exit end 52 increasing the cooling effect of the sleeve 72. Preferably the end 74 is extended to a distance beyond the exit end 52 of from 1 to 5 times the diameter of the injector tube 50. The most preferred range is from 1 to 2 times the diameter of the injector tube 50. The same extension can be accomplished with the embodiment shown in FIG. 5 depending on the length of the sleeve 72 and depth of the recessed portion 80.

The effects of certain design changes can be simulated using the Computational Fluid Dynamics (CFD) computer program FLUENT available from Fluent, Inc. The equations governing the steady-state flow and heat transfer process in a kinetic spray process are the mass, momentum, and energy conservation equations. The Fluent CFD code can handle interactions between the gas phase and the particles in terms of momentum and energy. To account for turbulence in a gas flow, a k-ε turbulence model was employed. This model is found in “The Numerical Computation of Turbulent Flows, Computer Methods in Applied Mechanics and Engineering”, 3, by B. E. Launder and D. B. Spalding, 1974, PP 269-289. An axi-symmetric model was generated to simulate gas flow and heat transfer around the powder injector tube 50. For the boundary conditions a mass flow rate of 0.0163 kg/s and a main gas temperature of 590° C. were specified at the nozzle 34 inlet. For the injector 48 a powder flow rate of 0.003 kg/s and a powder gas flow temperature of 80° C. were used. At the nozzle 34 walls a non-slip condition was specified. The air gap 76 was set at 100 microns. The computational model for conjugate heat transfer can predict the temperature of the injector 50, the Macor® sleeve 72 and the gas temperature around the injector 50. The material properties used in the model were as given below in Table 1

TABLE 1

| Property | Injector | Macor ® sleeve | Air gap |
|---|---|---|---|
| Density (kg/m³) | 8030 | 2520 | 1000 |
| Specific heat (J/kg | 502.5 | 790 | 700 |
| K) | | | |
| Thermal | 16.3 | 1.46 | 0.03 |
| Conductivity | | | |
| (W/m K) | | | |

FIG. 7A is a graph showing use of the FLUENT program to simulate the effect of with or without a 100 micron air gap 76 on the injector temperature versus the thermal conductivity of a sleeve material. In FIG. 7A reference line 84 represents the case with no air gap 76 and reference line 86 represents the case with a 100 micron air gap 76. It can be seen that as expected the lower the thermal conductivity of the sleeve material the lower the injector temperature. In addition, the presence of an air gap 76 also helps lowers the injector temperature at all thermal conductivities. Thus, an air gap 76 is very beneficial in protecting the injector tube 50 from high temperatures.

In FIG. 7B the effect of extending the sleeve 72 end 74 beyond the exit end 52 of the injector tube 50, as shown in FIG. 6, by a distance of 1.2 times the diameter of the injector tube 50 on the injector tube 50 temperature is shown as calculated using the FLUENT program. Note the horizontal axis is the normalized length of the injectors 50. The reference line 88 represents a sleeve 72 as shown in FIG. 4 wherein the sleeve 72 end 74 is flush with the exit end 52 of the injector tube 50. Reference line 90 represents a sleeve 72 as shown in FIG. 6 wherein the sleeve 72 end 74 extends beyond the exit end 52 of the injector tube 50 by 1.2 times the diameter of the injector tube 50. As a first matter it can be seen that the injector tube 50 temperature rises as one goes further into the nozzle 34. Second, when the end 74 is flush with the exit end 52 there is a dramatic rise in temperature very near the exit end 52. By way of contrast reference line 90 shows the dramatic benefit of extending the sleeve 72. In the extended embodiment the temperature actually drops near the exit end 52.

FIG. 7C was also generated using FLUENT. The purpose was to test the effect of sleeve wall thickness on cooling effect for a sleeve made from Macor®. Reference line 92 represents a wall thickness of 0.5 millimeters, reference line 94 represents a wall thickness of 1.1 millimeters, and reference line 96 represents a wall thickness of 1.7 millimeters. As can be seen from the figure there is little benefit to increasing the wall thickness beyond 0.5 millimeters for Macor® in this system. This is because when the wall thickness of Macor® is increased the surface area of the Macor® exposed to the surrounding high temperature main gas is also increased. Therefore, the heat transfer rate through the exposed surface area exceeds the effect of the thermal insulation caused by increasing the Macor® wall thickness.

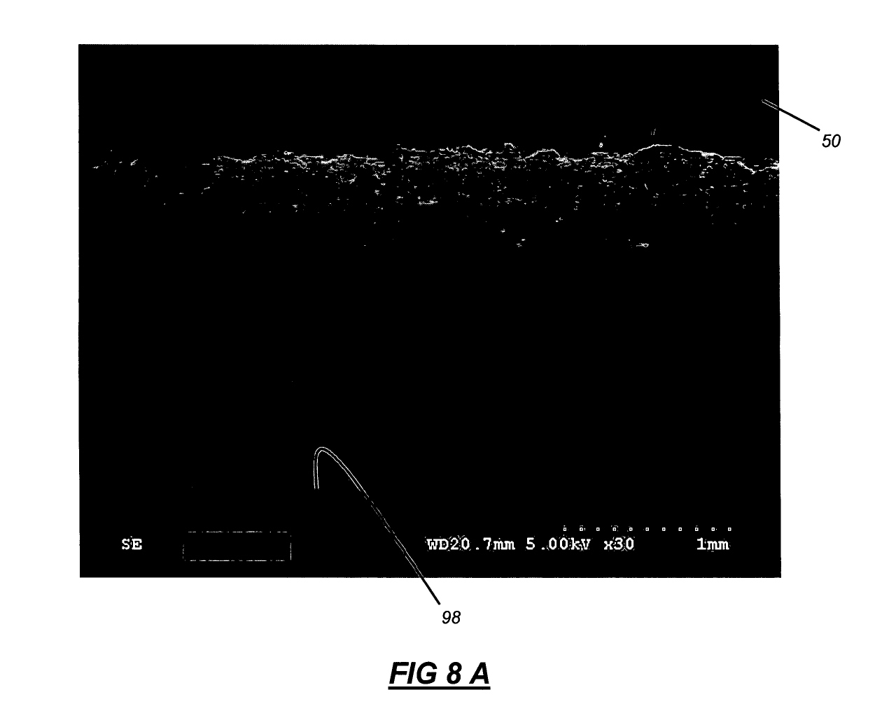

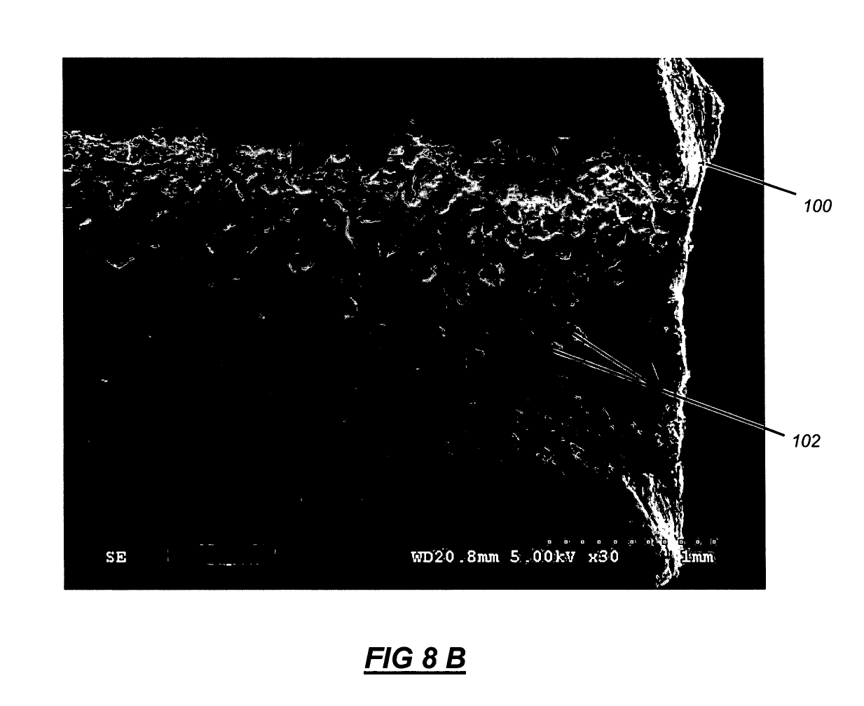

FIGS. 8A and 8B are SEM micrographs of cross-sections of injector tubes designed in accordance with FIG. 5 wherein the sleeve 72 includes a recessed portion 80 and the injector tube 50 includes a flared portion 82. This injector tube 50 was used for 4 hours at a temperature of 593° C. with the Al—Zn—Si alloy described above. FIG. 8A is from an interior section and one can see that an interior portion 98 has no particles adhered to the injector tube 50. FIG. 8B is taken from the exit end 100 and one can see just a few particles 102 are adhered to the interior of the injector tube 50. This is in marked contrast to FIG. 3B which was run at an even lower temperature and for only 10 minutes. FIGS. 8A and 8B show the benefit of the sleeve 72 of the present invention. Subsequent testing for well over 100 hours has shown that there is no decrease in effectiveness of the injector tube 50 when coupled with a sleeve 72 according to the present invention.

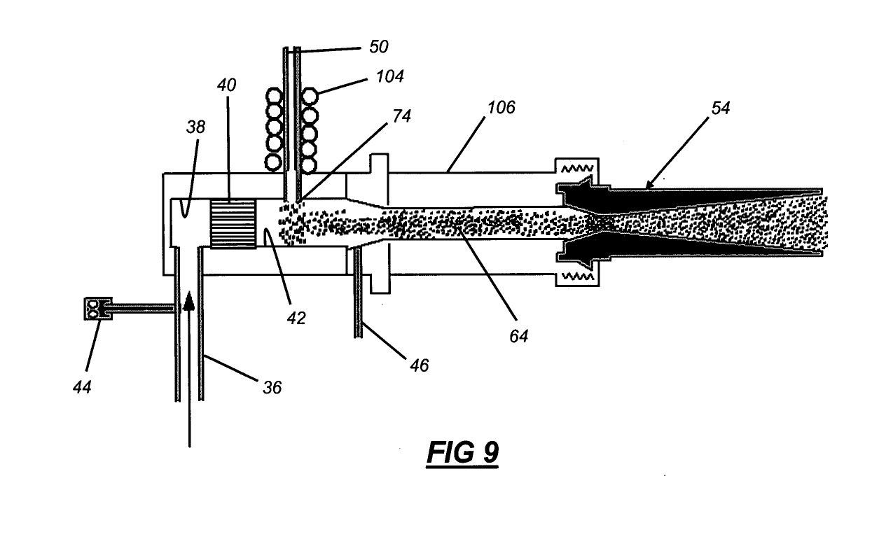

FIG. 9 represents another embodiment of the present invention. In this embodiment the injector tube 50 injects the powder 64 into the mixing chamber in a non-coaxial manner thus it is not subjected to the high temperatures. A sleeve 72 can still be incorporated around the injector tube 50. In addition, an extended powder/gas conditioning chamber 106 is included between the mixing chamber 42 and the de Laval nozzle 54. This exchange chamber 106 helps in entraining the powder 64. Preferably a longitudinal length L of the exchange chamber 106 ranges from 20 to 1000 millimeters. When high particle temperatures are required for coating formation, an extended powder/gas conditioning chamber 106 can be heated via a furnace, heating coil, or other heating device, not shown but known in the art. In these cases that involve high temperatures optional cooling coils 104 can also be used to maintain suitable injector tube 50 temperatures.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A powder injector for a kinetic spray nozzle, said powder injector comprising: an injector tube and a sleeve;
said injector tube received in said sleeve and secured to said sleeve; and
an air gap defined between an inner diameter of said sleeve and an outer diameter of said injector tube wherein said air gap is from 25 to 200 microns.

2. A powder injector as recited in claim 1, wherein said sleeve is formed from a material having a thermal conductivity that is less than the thermal conductivity of the material that the injector tube is formed from.

3. A powder injector as recited in claim 1, wherein said sleeve is formed from a material having a thermal conductivity of 15.00 W/m K or less.

4. A powder injector as recited in claim 1, wherein said sleeve is formed from a material having a thermal conductivity of 5.00 W/m K or less.

5. A powder injector as recited in claim 1, wherein said sleeve is formed from a machinable ceramic material.

6. A powder injector as recited in claim 4, wherein said machinable ceramic material comprises SiO₂, MgO, Al₂O₃, K₂O, B₂O₃, and F.

7. A powder injector as recited in claim 4 wherein said sleeve is formed by sintering or casting.

8. A powder injector as recited in claim 1, wherein said sleeve is formed from a material having a continuous use temperature of at least 400° C.

9. A powder injector as recited in claim 8, wherein said sleeve is formed from a material having a continuous use temperature of at least 500° C.

10. A powder injector as recited in claim 1, wherein said sleeve is formed from a ceramic material.

11. A powder injector as recited in claim 1, wherein said injector tube is secured to said sleeve by an adhesive.

12. A powder injector as recited in claim 1, wherein said injector tube has an exit end and said exit end of said injector tube is flush with an end of said sleeve.

13. A powder injector as recited in claim 1, wherein said sleeve has an end that extends beyond an exit end of said injector tube.

14. A powder injector as recited in claim 13, wherein said end of said sleeve extends beyond said exit end of said injector tube by a distance of from 1 to 5 times the diameter of said injector tube.

15. A powder injector as recited in claim 13, wherein said end of said sleeve extends beyond said exit end of said injector tube by a distance of from 1 to 2 times the diameter of said injector tube.

16. A powder injector as recited in claim 1, wherein said sleeve has an end having a recessed portion therein and said injector tube has an exit end with a flared portion, said flared portion received in said recessed portion and thereby securing said injector tube to said sleeve.

17. A powder injector as recited in claim 1, further comprising a cooling coil coiled around a portion of said sleeve.

18. A powder injector as recited in claim 1, wherein said air gap is from 25 to 200 microns.

19. A powder injector as recited in claim 1, wherein said air gap is from 50 to 150 microns.
